(19) United States
(12) Patent Application Publication
(10) Pub. No.: US 2012/0156037 A1
(43) Pub. Date: Jun. 21, 2012

(54) Foil, utilized such as an airfoil or hydrofoil, characterized by a duct moving relative to a mass of fluid. A constriction within the duct increases the speed of the fluid flowing within the duct and thereby produces a pressure drop inducing a mass of fluid external to the duct to accelerate into the duct. The acceleration of the fluid into the duct generates a resultant force, which can be varied and controlled to improve performance and reduce drag

(76) Inventor: Phillip Jackson McGee, Cleveland, MS (US)

(21) Appl. No.: 13/373,714

(22) Filed: Nov. 28, 2011

Related U.S. Application Data
(60) Provisional application No. 61/459,687, filed on Dec. 17, 2010.

(51) Int. Cl. F01D 5/18; F04D 29/38; B63H 9/04; B64C 3/00; B64C 21/02; B63H 1/02; B64C 11/20; F03B 3/12

(52) U.S. Cl. 416/91

(57) ABSTRACT

A foil, utilized such as an airfoil or hydrofoil, characterized by a duct moving relative to a mass of fluid. The duct channels the flow of the portion of the fluid through which the duct is moving. A constriction within the duct increases the speed of the fluid constrained within the duct and thereby produces a pressure drop. The pressure drop induces a mass of fluid external to the duct and approximately parallel to the duct to accelerate into the duct. The acceleration of the external fluid mass into the duct generates a resultant force vector, which can be utilized, varied, and controlled to improve performance and reduce drag.

This application claims priority from applicant's U.S. Provisional Patent Application No. 61/459,687, filed on Dec. 17, 2010.

A foil, utilized such as an airfoil or hydrofoil, characterized by a duct moving relative to a mass of fluid. A constriction within the duct increases the speed of the fluid flowing within the duct and thereby produces a pressure drop inducing a mass of fluid external to the duct to accelerate into the duct. The acceleration of the fluid into the duct generates a resultant force, which can be varied and controlled to improve performance and reduce drag.

### CROSS-REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

The present invention is in the technical field of fluid movement and performance, more particularly, to foils. It is applicable more particularly, but not exclusively, to the production of the fixed wing of an aircraft. However, the invention may also be applied to the production of the wing of an aircraft with rotary wings. The invention may also be applied to the production of the impellers, turbines, sails, and propellers.

When a foil is moved relative to a fluid the foil produces a force. A foil is a two-dimensional cross sectional shape, at some point in the span, of a section of a fluid moving device including the blade of a propeller, rotor, or turbine; or wing such as provided for aircraft or watercraft. Foil properties are used to calculate and design three-dimensional (3D) wing and blade properties. The term “foil” makes no distinction for the type of fluid (e.g., air, gases, liquids, plasma), even though sometimes referring to an “airfoil” or “hydrofoil”.

For over 100 years, the prior art has never completely understood the dynamics of a foil. Traditionally, several approaches and theories have been taken to design foils. While the prior art concedes that Newton's laws of motion and Bernoulli's Principle are applicable the prior art has never determined how to apply them for a direct analytical mathematical solution.

National Aeronautics and Space Administration (NASA), Glen Research Center, Bernoulli and Newton, http://www.grc.nasa.gov/WWW/K-12/airplane/bernnew.html, available on the Internet; is hereby incorporated by reference.

One theory in prior design, of foils, has relied on the assumption that the different velocities of the fluid movement over the camber of the chord of the upper surface of the foil and the lower surface of the foil creates differential pressures and theoretically causes a net force normal to the direction of higher to lower fluid pressure, (e.g., generally vertical for aircraft). This is sometimes referred to as the “equal transit time theory”.

The vector component of this total force, vertical and pointing parallel to the force of gravity (for cruising aircraft) is sometimes called “lift”.

But, the total force also produces an undesirable vector component, horizontal and parallel to the force of gravity (for cruising aircraft), sometimes called “induced drag”.

National Aeronautics and Space Administration (NASA), Glen Research Center, Incorrect Theory #1, Longer Path or Equal Transit Theory, http://www.grc.nasa.gov/WWW/K-12/airplane/wrong1.html, available on the Internet; is hereby incorporated by reference.

Another approach in prior design of foils has based the lift provided by the foil on the theoretical dynamic pressure induced by the “angle of attack” on the lower surface area of the foil with the fluid flow. This theory presupposes that only the lower surface produces lift. But, this net force produced by the dynamic pressure acting upon the pitched surface of the foil also produces an undesirable vector component, horizontal and parallel to the force of gravity (for cruising aircraft), sometimes called “profile drag”.

National Aeronautics and Space Administration (NASA), Glen Research Center, Incorrect Theory #2, Skipping Stone Theory, http://www.grc.nasa.gov/WWW/K-12/airplane/wrong2.html, available on the Internet; is hereby incorporated by reference.

Another theory is based on the idea that the airfoil upper surface is shaped to act as a nozzle, which accelerates the flow. Such a nozzle configuration is called a Venturi nozzle and it can be analyzed analytically to an exact solution. But an airfoil is not a Venturi nozzle. There is no phantom surface to produce the other half of the nozzle. NASA's experiments noted that the velocity gradually decreases as you move away from the airfoil eventually approaching the free stream velocity. This is not the velocity found along the centerline of a conventional nozzle, which is typically higher than the velocity along the wall.

National Aeronautics and Space Administration (NASA), Glen Research Center, Incorrect Theory #3, Venturi Theory, http://www.grc.nasa.gov/WWW/K-12/airplane/wrong3.html, available on the Internet; is hereby incorporated by reference.

Since the prior art has not derived a direct mathematical analytical solution, existing design methods, for conventional foils, involves collecting data from wind tunnel tests. This method tests the current foil subject but is inaccurate when attempts are made to extrapolate the test data to other foil configurations.

Generally, profile drag and the induced drag represent the largest contributions to the total foil drag. Traditional design has targeted a reduction in profile drag. Traditionally design approaches have had to compromise between profile drag and generally fixed induced drag in order to produce acceptable lift at preferred fluid characteristics and relative motion between the foil and the fluid.

A diligent search revealed no prior references disclosing a foil characterized by a duct moving relative to a mass of fluid with a constriction within the duct. While reducing the area of a duct to induce an external fluid to flow into to the duct is common to venturi nozzles this class would not apply to a foil characterized by a duct moving relative to a fluid.

There exists, therefore, a need for a foil that has improved performance and that can be analytically calculated to an exact solution.

### BRIEF SUMMARY OF THE INVENTION

The meaning of “foil” as used by this inventor refers to the use and application of the foil of prior art and of the present invention rather than particular shape, appearance, or design of the prior art, since this inventor's foil shape, appearance, and design is novel and unique compared to foils of the prior art. The use of the term foil can also apply to a three-dimensional (3D) shape embodied by the two-dimensional (2D) cross sectional view of the foil of the present invention.

According to one aspect of the invention there is provided a foil, which forms a duct, to channel the flow of a fluid from an inlet to an outlet.

The invention is characterized by a duct with an actual physical top, bottom, and two sides which constrains the flow of fluid from the inlet to the outlet. This enclosed duct therefore completely circumvents the NASA, Glenn Research Center, Incorrect Theory #3, Venturi Theory, argument, “There is no phantom surface to produce the other half of the nozzle.” pursuant to reference:

National Aeronautics and Space Administration (NASA), Glen Research Center, Incorrect Theory #3, Venturi Theory. http://www.grc.nasa.gov/WWW/K-12/airplane/wrong3.html, available on the Internet; is hereby incorporated by reference.

According to another aspect of the invention, the contained flow of fluid within the duct is channeled to a constricted area in the duct. This constriction, in the duct, increases the speed of the fluid within this constriction to satisfy the law of conservation of mass. This increase in speed results in a reduction in the fluid pressure within the duct. This reduction in fluid pressure causes an additional mass of fluid to be accelerated into the duct through an external opening in the duct. This combination of mass (M) and acceleration (A) of external fluid thus applies a force (F) vector pursuant to Newton's classical equation of motion, F (force)=M (mass) times A (acceleration). In the present invention both the magnitude and directional components of any force vectors (F) can be beneficially designed, predicted, and controlled.

The directional component of this force vector (F) can be designed into the foil or adjusted independently, of the internal fluid flow through the foil and within the duct. The force vector (F) and be directed towards the preferred direction (e.g., lift, vertical and pointing up for cruising aircraft). Since the direction and magnitude components of force vector (F) are pointed in the preferred direction there is no component of the force vector (F) perpendicular to the desired direction of lift and induced drag is substantially reduced. Thus, the present invention provides a foil that improves performance by providing control of the magnitude and directional components of the force vector (F) in order to maximize the force of lift, in the preferred direction.

In the present invention profile drag is independent of induced drag. In the present invention profile drag caused by fluid flow over the external surface structure of the foil is also independent of the foil internal fluid flow which produces the desired force, sometimes called lift. The present invention provides an improved foil design that allows profile drag to be reduced without compromising the force of lift.

A three dimensional shape (e.g., blade of a propeller, rotor, or turbine, wing, sail) can be constructed from this two dimensional foil in varying combinations of rectangular, circular, or other shape to apply a preferred vector of force. (e.g., lift, rotation, stability, control).

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated one of many possible embodiments of the invention.

### BRIEF DESCRIPTION OF THE SEVERAL VIEWS OF THE DRAWINGS

The drawings constitute a part of this specification and include exemplary embodiments to the invention, which may be embodied in various forms. It is to be understood that in some instances various aspects of the invention may be shown exaggerated, enlarged, or reduced to facilitate an understanding of the invention.

FIG. 1 is a two-dimensional (2D) right side view of the foil with the right side endplate in place and the outline of the foil behind the endplate shown as a dashed line

FIG. 2 is a two-dimensional (2D) right side view of the foil with the right side endplate removed for clarity

FIG. 3 is a perspective view of the foil depicted as a three-dimensional (3D) wing mounted on a conventional aircraft looking from the front of the aircraft into the intake of the foil.

FIG. 4 is a perspective view of the foil depicted as a three-dimensional (3D) wing mounted on a conventional aircraft looking from above the aircraft into the external opening of the foil.

FIG. 5 is a perspective view of the foil depicted as a three-dimensional (3D) wing mounted on a conventional aircraft looking from behind the aircraft into the outlet of the foil.

### DETAILED DESCRIPTION OF THE INVENTION

A detailed description of one possible embodiment of the invention, a two-dimensional (2D) airfoil, sometimes depicted as a three-dimensional (3D) aircraft wing, is provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A more complete understanding of the invention and many of the attendant advantages thereof will be readily appreciated as the same becomes better understood by reference to the following detailed description when considered in connection with the accompanying drawings wherein: analogous parts are identified by like reference numerals as follows:
100 Right endplate
101 Inlet
101A Fluid flow into inlet
102 Constriction
102B Combined fluid flow into constriction
103 External opening
103C Fluid flow into external opening
104 Outlet
104D Fluid flow from outlet
105 Direction of foil travel
106 Outline of foil hidden behind right endplate
112 Force vector exerted on foil near external opening
113 Force vector exerted on foil near outlet
114 Right side airfoil with the right side endplate removed
200 Right side airfoil with the right side endplate removed and linear slide valve and flap valve in their retracted positions
201 Right side airfoil with the right side endplate removed and linear slide valve and flap valve in their extended positions
202 Linear slide valve to vary external opening
203 Rotating flap valve to vary outlet configuration
204 Actuator to vary linear slide valve at external opening
205 Actuator to rotate valve flap at outlet
300 Foil depicted as a three-dimensional (3D) aircraft wing
400 Conventional aircraft attached to foil depicted as a three-dimensional (3D) aircraft wing

Similar to fixed aircraft wing, rotary aircraft wings, submerged marine propellers, aircraft propellers, airboat propellers, water craft sails, power generating turbines, gas compressors, fans, and pump impellers the present invention can be made in various sizes and configurations including, but not exclusively, with any size of intake, outlet, external opening, and length. It should be recognized that the present invention is not limited to the use in aircraft wings having the specific designs that are herein described for purposes of example.

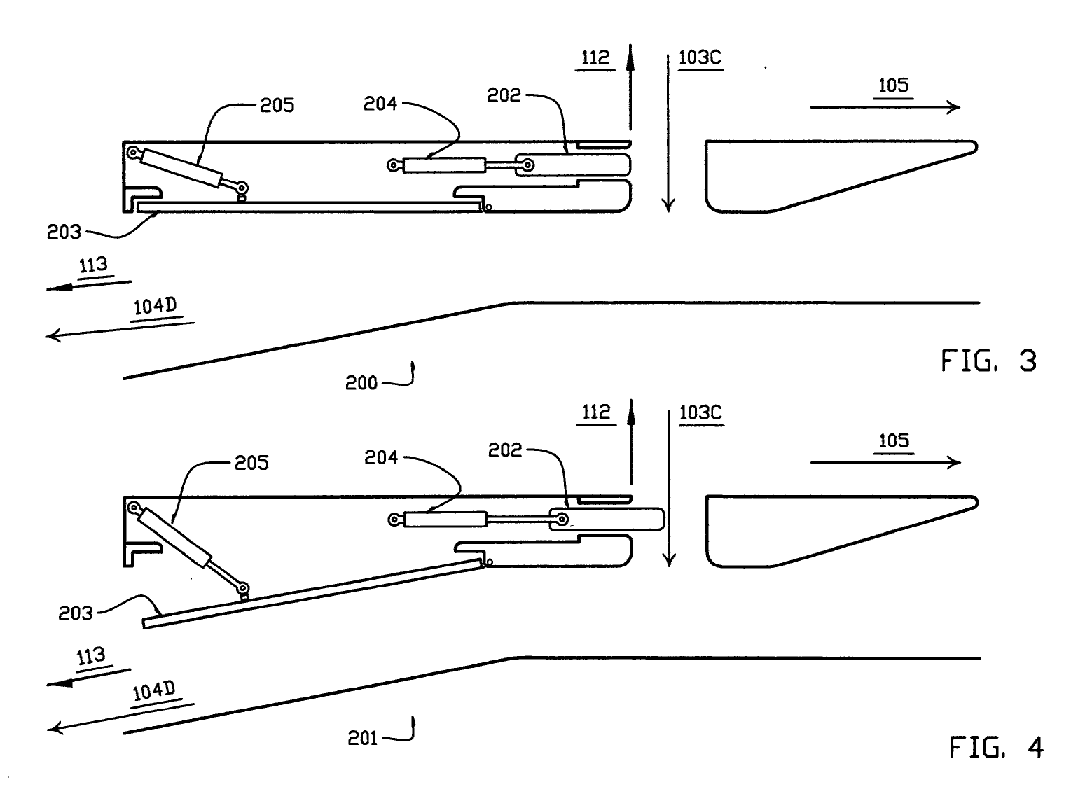

Referring to FIG. 2 of the drawings, the embodiment of the present invention, as an airfoil 114 has an inlet 100, external opening 103, an outlet 104, and a constriction 102.

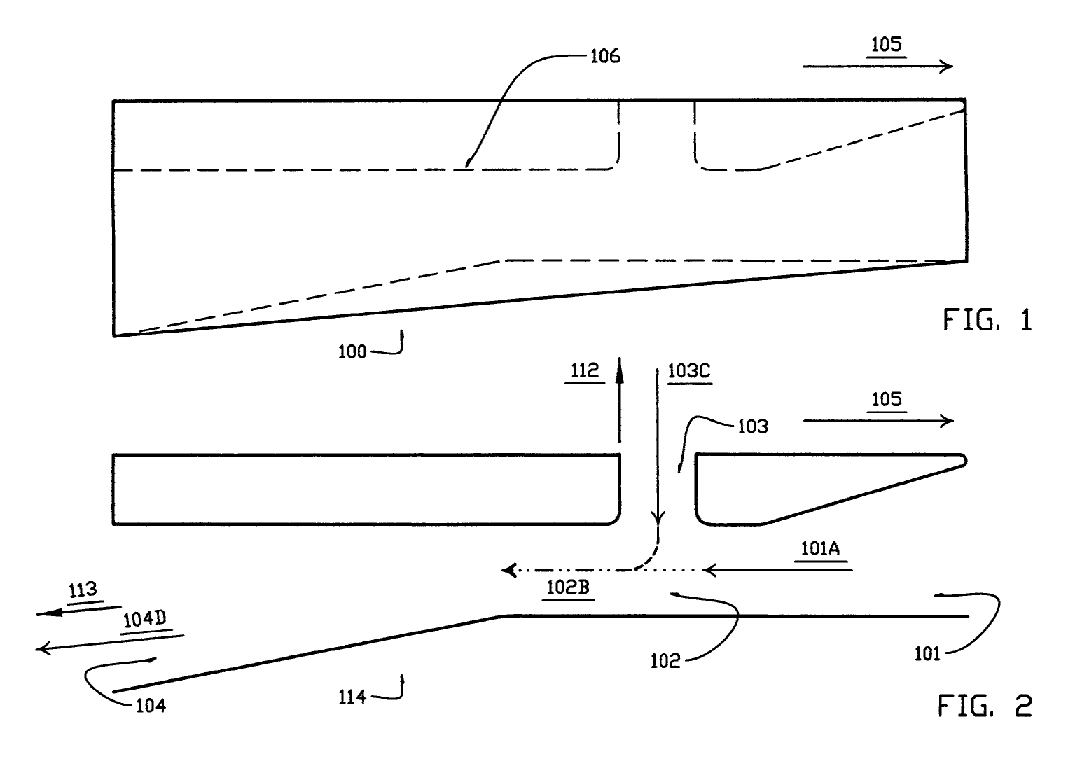

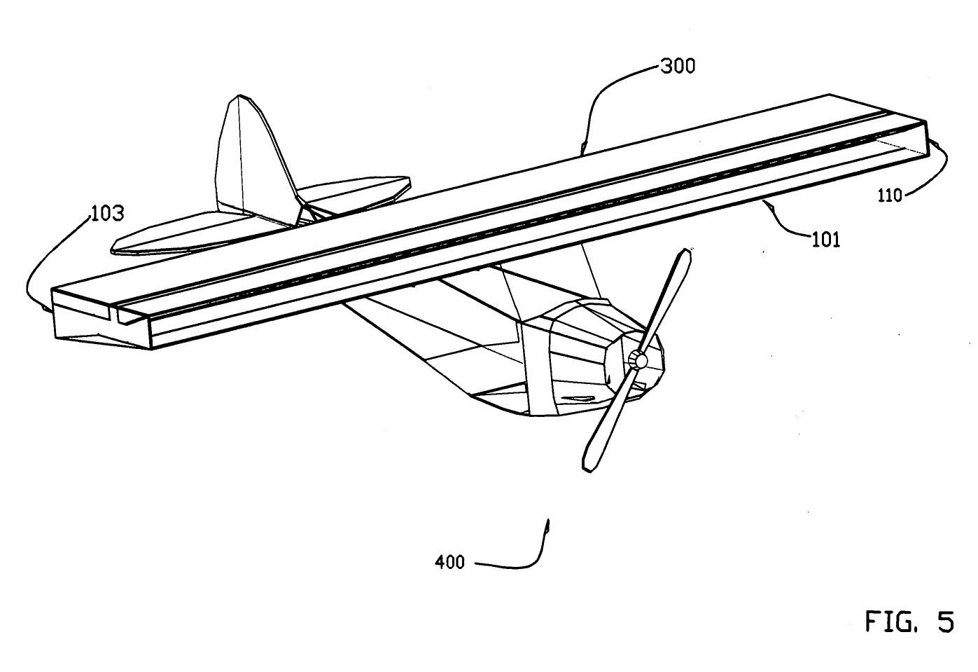

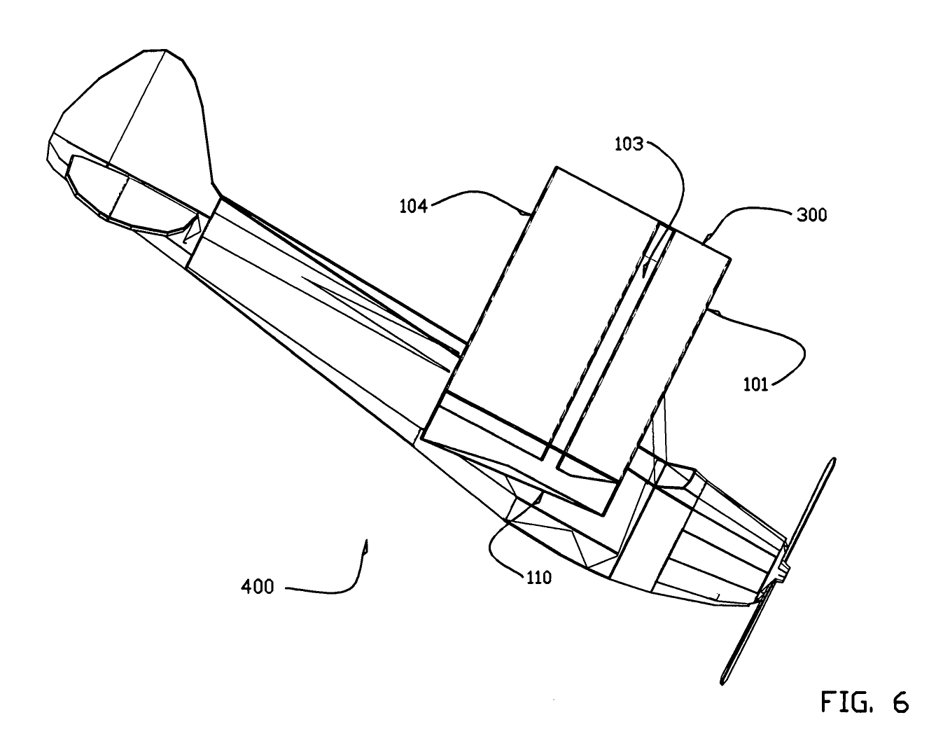

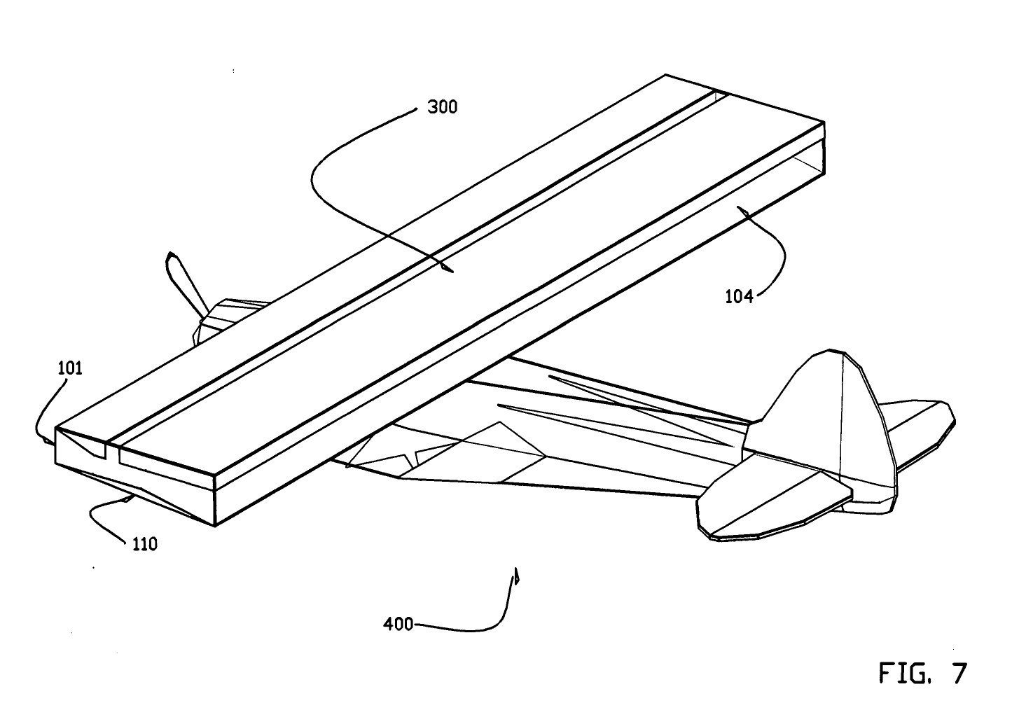

Referring jointly to FIG. 1, FIG. 2, FIG. 3, FIG. 4, FIG. 5, FIG. 6, and FIG. 7 the endplates typical of right endplate 100 of FIG. 1 constrain all the fluid flow from inlet 100 to outlet 104 of airfoil 114. The endplates typical of right endplate 100 prevent fluid from escaping from the ends of a three-dimensional airfoil embodied as a wing on an aircraft 500, 600, and 700.

The foil 114 of the present invention provides a duct for the fluid flow 101A entering the foil 114 at the intake 101 to be channeled to a constriction 102 which increases the velocity of the fluid 102B in the constriction 103 and thereby reduces the pressure of the fluid 102B. This reduction in fluid pressure at the constriction 102 causes a flow of fluid 103C to accelerate into the external opening 103 into the foil 114.

The mass of external fluid 103C accelerating into the foil 114 thus applies a force vector 112.

The foil 114 of the present invention also provides an outlet 104 for the fluid flow 104D exiting the foil 114. The area of the outlet 104 is designed to control the speed of the fluid 104D exiting the outlet 104. The angle of the outlet 104 is designed to control the direction of the fluid 104D exiting the outlet 104.

The velocity vector components of speed and direction of the fluid flow 104D determine the force vector 113.

In this embodiment of the present invention as an airfoil both the magnitude and directional components of the force vectors 112 and 113 can be beneficially designed, predicted, and controlled pursuant to control of the fluid flows 103C and 104D. A three-dimensional (3D) shape (e.g., fixed aircraft wing, rotary aircraft wings, submerged marine propellers, aircraft propellers, airboat propellers, water craft sails, power generating turbines, gas compressors, fans, and pump impellers) can be constructed from the foil 114 of the present invention in varying combinations of rectangular, circular, or other shape to apply the preferred magnitude and directional components of the force vectors 112 and 113 (e.g., lift, rotation, stability, control).

In FIG. 5 of the drawings, the embodiment of the present invention, as an airfoil is depicted as being utilized as a wing 300 for a conventional aircraft 400. The aircraft 500 is depicted looking from the front into the intake 101 of the foil.

In FIG. 6 of the drawings, the embodiment of the present invention, as an airfoil, is depicted as being utilized as a wing 300 for a conventional aircraft 400. The aircraft 600 is depicted looking from above into the external opening 103 of the foil.

FIG. 7 illustrates the embodiment of the present invention, as an airfoil is depicted as being utilized as a wing 300 for a conventional aircraft 400. The aircraft 700 is depicted looking from behind into the outlet 104 of the foil.

FIG. 2 and FIG. 3 illustrate an embodiment of the present invention, configured for variable configurations, 200 and 201 with valves 202 and 203 and actuators 204 and 205 designed to vary the fluid flows 103C and 104D. Varying the fluid flows 103C and 104D thus varies the force vectors 112 and 113.

In FIG. 3 valves 202 and 203 and actuators 204 and 205 are in their retracted positions.

In FIG. 4 valves 202 and 203 and actuators 204 and 205 are in their extended positions thus changing the speed and directional components of force vectors 112 and 113.

The elements embodied in FIG. 1, FIG. 2, FIG. 3, FIG. 4, FIG. 5, FIG. 6, and FIG. 7 configured for flow of lower density fluids, such as air, can be constructed by conventional manufacturing techniques. This includes, but is not limited to, assembling spars and ribs to create a sub-structure, and overlaying a skin over this sub-structure to provide an aerodynamic surface. State-of-the-art composite fabrication techniques can be used. The materials used in the construction of the embodiments represented by FIG. 1, FIG. 2, FIG. 3, FIG. 4, FIG. 5, FIG. 6, and FIG. 7 are similar to those typically used in the relevant industry (e.g., aerospace, automotive, wind turbines, watercraft). This includes, but is not limited to, metals, plastics, fabrics, and/or composite materials. In the case of sails, parachutes or other winged equipment the fabric membrane can be constructed so as to maintain its shape comprised of tensioning components such as wire or fabric line to hold the shape of the wing and using the pressure of fluid to keep the foil inflated to shape.

The elements and mechanism to rotate and move 202 and 203 can be constructed by conventional manufacturing techniques. This includes, but is not limited to, assembling spars and ribs to create a sub-structure, and overlaying a skin over this sub-structure to provide an aerodynamic surface. Typical metal “flat plate” fabrication techniques can also be applied. The materials used in the construction of the movable elements are similar to those typically used in the relevant industry (e.g., aerospace, automotive, wind turbines, watercraft). This includes, but is not limited to, metals, plastics, fabrics, and/or composite materials.

The elements of the foil configured for flow of medium to higher density fluids, such as water, can be constructed by conventional manufacturing techniques. This includes, but is not limited to, machine cutting and fabricating from metal or plastic or a combination of materials.

Rotating hinges and linear bearings where applicable are similar to those typically used in the relevant industry. Standard conventional actuating equipment such as electromechanical or fluid filled actuators for positioners 204 and 205 can be used to vary the position of 202 and 203.

With the embodiments described above one skilled in the development of foils can devise specific shapes for the foil elements that will achieve the benefits of the invention. The foil, of the present invention, can also be used in any position or angle to provide a downward or horizontal force. The foil of the present invention can be used vertically as a “sail” on a watercraft, where the foil of the present invention would produce a horizontal force to propel the watercraft in a horizontal direction.)

While the foil depicted in FIG. 1, FIG. 2, FIG. 3, FIG. 4, FIG. 5, FIG. 6, and FIG. 7 has a specific configuration, it is not the only foil configuration operable with the present invention. As will be set out below, rather than the invention being specific foil configuration, it is the interaction of the fluids flows at the inlet, outlet, constriction, and external opening and their combined effect on the parameters of fluid flow that provides the benefits of the invention.

With the embodiment described above one skilled in the development of foils can devise specific shapes for the foil elements that will achieve the benefits of the invention.

The advantages of the present invention include, without limitation that it improves performance and efficiency. The resulting performance of a foil designed pursuant to the embodiments of the present invention are predictable and repeatable. The configuration of the foil of the present invention can be designed, adjusted and controlled to provide the preferred and predictable results.

While the invention has been described in connection with the embodiments illustrated above, it is not intended to limit the scope of the invention to the particular form set forth, but on the contrary, it is intended to cover such alternatives, modifications, and equivalents as may be included within the spirit and scope of the invention. It is recognized that various equivalents, alternatives and modifications are possible within the scope of the appended claims and their legal equivalents. While several forms of the invention have been shown and described in the above teachings, other forms will now be apparent to those skilled in the art. Therefore, it will be understood that the embodiments shown in the drawings and described above are merely for illustrative purposes, and are not intended to limit the scope of the invention which is defined by the claims which follow.

What I claim is:

1. A foil comprised of:
(a) a duct, with an inlet on one end and outlet on the other end, that moves relative to a mass of fluid and conveys the flow of a portion of the said mass of fluid, internally within the said duct, from the said inlet to the said outlet;
(c) a constriction in the said duct, between the said inlet and said outlet, which causes an increase in speed of the internal fluid flow and a reduction in pressure of the said internal fluid; and
(c) an external opening to the said duct, at an angle to the flow of said internal fluid, located near or at the said constriction that allows additional fluid to flow into the said duct;

2. The foil of claim 1, constructed as a three-dimensional wing, vane, or blade in any combination of rectangular, planar, circular, or other shape used to apply a magnitude and directional component of vector force to provide lift, stability, control, or rotational torque.

3. The foil of claim 1, used for all types and mixtures of fluids including air, gases, liquids, and plasma.

4. The foil of claim 1, wherein: the configuration of said duct is fixed.

5. The foil of claim 1, wherein: the configuration of said duct is variable.

6. The foil of claim 1, wherein: the magnitude and direction of the force vector applied to the foil are variable.

7. The foil of claim 6, wherein: the configuration of said duct is adjusted in response to preferred parameters.

8. The foil of claim 1, wherein: the configuration of said inlet, outlet, and external opening are fixed.

9. The foil of claim 1, wherein: the configuration of said inlet, outlet, and external opening are variable.

10. The foil of claim 9, wherein: the configuration of said inlet, outlet, and external opening are adjusted in response to preferred parameters.

11. The foil of claim 1, disposed to operate in a regime to generate lift.

12. The foil of claim 1, disposed to operate as a control surface.

13. The foil of claim 1 wherein: the configuration of said duct is substantially linear.

14. The foil of claim 1 wherein: the flow of fluid inside said duct is substantially non-linear.

15. The foil of claim 1, disposed to operate as a fixed aircraft wing, rotary aircraft wing, marine propeller, aircraft propeller, airboat propeller, watercraft sail, power generating turbine, compressor, fan, or pump impeller.

16. The foil of claim 1, wherein: any edge of any endplate extends beyond the boundaries of the fluid channel of the foil.

17. The foil of claim 1, wherein: the fluid through said inlet, outlet, or external opening is caused to move by a powered fluid moving device.

18. The foil of claim 1, wherein: the fluid inside the said duct is caused to flow by moving the said duct through a substantially stationary body of fluid.

19. The foil of claim 1, wherein: the fluid inside the said duct is caused to flow by a body of fluid moving parallel to the flow of fluid within the said duct.
